(19) United States
(12) Patent Application Publication
(10) Pub. No.: US 2026/0341038 A1
(43) Pub. Date: Oct. 29, 2026

(54) SYSTEM FOR CORRECTLY RECOGNIZING SPECIAL VEHICLE OBJECT BY USING ARTIFICIAL INTELLIGENCE AND AUTONOMOUS DRIVING SENSOR AND METHOD IMPLEMENTING THE SAME

(71) Applicants: Hyundai Motor Company, Seoul (KR); Kia Corporation, Seoul (KR)

(72) Inventor: Ju Heon BAEG, Hwaseong-Si (KR)

(21) Appl. No.: 19/410,472

(22) Filed: Dec. 5, 2025

(30) Foreign Application Priority Data
Apr. 28, 2025 (KR) 10-2025-0055681

(51) Int. Cl. G06V 20/58; B60W 60/00; G01S 17/89; G01S 17/931; G06V 10/74; G06V 10/762; G06V 10/764; G06V 10/766

(52) U.S. Cl. CPC G06V 20/58; B60W 60/001; G01S 17/89; G01S 17/931; G06V 10/761; G06V 10/762; G06V 10/764; G06V 10/766; B60W 2552/05; B60W 2554/4044; G06V 2201/08

(57) ABSTRACT

An apparatus of a vehicle may comprise a sensor configured to obtain point cloud data associated with an object in a surrounding environment of the vehicle, a memory configured to store the point cloud data, and a processor circuit configured to select, from among a plurality of point clusters derived from the point cloud data, a point cluster satisfying both a location condition and a dimension condition corresponding to a special-purpose vehicle. The processor circuit may classify the selected point cluster based on at least one reference height, extract outer points forming an outer shape, determine height-specific polynomial regression coefficients, determine whether the selected point cluster corresponds to the special-purpose vehicle, output a signal indicating the correspondence, and control driving of the vehicle.

### CROSS-REFERENCE TO RELATED APPLICATION

This application claims the benefit of priority to Korean Patent Application No. 10-2025-0055681, filed in the Korean Intellectual Property Office on Apr. 28, 2025, the entire contents of which are incorporated herein by reference.

### TECHNICAL FIELD

The present disclosure relates to a system and a method for accurately recognizing a special vehicle object by using an autonomous driving sensor and an artificial intelligence (AI), and more particularly, relates to an AI-based special vehicle recognition system that may improve the phenomenon that object recognition performance by an autonomous driving sensor deteriorates due to the unique shape of each special vehicle, and a method thereof.

### BACKGROUND

A variety of sensors and artificial intelligence (AI) technologies are increasingly being used to support the autonomous driving function of a vehicle. For example, research is ongoing on an object in front of a moving vehicle, determining a distance between the object and the vehicle, and developing an algorithm in which the vehicle responds to specific situations to ensure safety.

Accordingly, vehicle sensor technologies are becoming advanced, and high-performance sensors such as Light Detection and Ranging (LiDAR) that recognizes surrounding environments by using laser beams, Radio Detection and Ranging (RADAR) that uses radio waves, an ultrasonic sensor, a fisheye camera capable of capturing 360-degree images, a multifocal lens, and a global positioning system (GPS) are being installed in vehicles.

As such, a super sensor vehicle may be implemented by aggregating measurement results obtained from a plurality of sensors. In self-driving (autonomous driving), the concept of a super sensor refers to a technology that accurately recognizes surrounding environments for comfort or safety by combining measured values from a variety of sensors rather than relying on individual sensors. Here, with the addition of information and communications technology (ICT) and cloud technology, sensors required for autonomous driving, and AI algorithms related thereto are becoming more sophisticated than ever, to increase the reliability of the determination of vehicle sensors by remotely accumulating data from numerous fleets of vehicles instead of targeting only a single vehicle and training an AI server and a database.

Among the sensors, the LiDAR sensor for recognizing external environments recognizes various objects on a road during autonomous driving by emitting a laser beam, and by measuring both the intensity of the laser and the time required for the laser beam to be reflected from surrounding objects.

Object recognition using the LiDAR and the AI algorithm is not perfect. In particular, despite the advancement of LiDAR sensing performance and the development of AI technology, the recognition rate of so-called special vehicles by autonomous driving sensors is low, and there is a high possibility of misrecognition. The reason is that each special vehicle has a unique and special shape. When the special vehicle is not accurately identified, the risk of an autonomous safety accident will inevitably increase.

Accordingly, a solution to overcome the problem of object misrecognition due to unique shapes of special vehicles is considered.

### SUMMARY

The matters described in this Background section are only for enhancement of understanding of the background of the disclosure, and should not be taken as acknowledgment that they correspond to prior art already known to those skilled in the art.

The present disclosure was made to solve the above-mentioned problems occurring.

An example of the present disclosure provides a system and a method for accurately recognizing a special vehicle object by using an autonomous driving sensor and an AI. An example of the present disclosure provides an AI-based special vehicle recognition system capable of improving the phenomenon that object recognition performance by an autonomous driving sensor deteriorates due to the unique shape of each special vehicle, and a method thereof.

Moreover, the technical challenges of the present disclosure are not limited to the technical challenges mentioned above, and other technical challenges not expressly mentioned will be apparent to those skilled in the art from the detailed description of the present disclosure and the accompanying drawings.

The technical problems to be solved by the present disclosure are not limited to the aforementioned problems, and any other technical problems not mentioned herein will be clearly understood from the following description by those skilled in the art to which the present disclosure pertains.

To solve all or at least part of the above-described technical problems, the present disclosure may be implemented in various examples as follows.

According to the present disclosure, an apparatus of a vehicle may comprise a sensor configured to obtain point cloud data associated with an object in a surrounding environment of the vehicle, a memory configured to store the point cloud data, and a processor circuit configured to select, from among a plurality of point clusters derived from the point cloud data, a point cluster that satisfies both a location condition and a dimension condition corresponding to a special-purpose vehicle. The processsor circuit may classify, based on at least one reference height, the selected point cluster as at least one height-specific point cluster, extract outer points that form an outer shape of the at least one height-specific point cluster, determine a plurality of height-specific polynomial regression coefficients based on spatial coordinate values of the outer points forming the outer shape of the at least one height-specific point cluster, determine whether the selected point cluster is associated with the object, wherein the object corresponds to the special-purpose vehicle, based on the plurality of height-specific polynomial regression coefficients and based on reference height-specific polynomial regression coefficients associated with the special-purpose vehicle, output, based on the determination of whether the selected point cluster is associated with the object, a signal indicating that the object corresponds to the special-purpose vehicle, and control, based on the signal, driving of the vehicle.

The location condition may comprise a two-dimensional (2D) or three-dimensional (3D) coordinate condition, and the dimension condition may comprise at least one of: a length of the object, a width of the object, or a ratio between the length and the width of the object.

The processor circuit may be configured to divide the at least one height-specific point cluster into a plurality of angular sections defined relative to a current location of the sensor, and select, as one of the outer points, a point closest to the current location of the sensor within each respective angular section of the plurality of angular sections.

The processor circuit may be configured to apply quadratic regression to two-dimensional coordinate values of the outer points to determine second-order polynomial coefficients.

The processor circuit may be configured to determine whether the selected point cluster is associated with the object based on a value obtained from a square root of one of the second-order polynomial coefficients.

The processor circuit may be configured to recognize the object as the special-purpose vehicle based on a length measured in a section between adjacent reference heights exceeding a threshold value, wherein the length is defined as a longitudinal distance between a first outer point with a minimum longitudinal location and a second outer point with a maximum longitudinal location, wherein the first outer point and the second outer point are among the outer points forming the outer shape of the at least one height-specific point cluster, wherein the threshold value is based on a product of a reference length and a predetermined parameter, wherein the reference length is based on the reference height-specific polynomial regression coefficients, and wherein the reference height-specific polynomial regression coefficients are in the section between the adjacent reference heights.

The processor circuit may be configured to determine a subclass of the special-purpose vehicle to which the selected point cluster belongs, and the special-purpose vehicle may have an irregular body shape different from body shapes of passenger vehicles.

The processor circuit may be configured to determine an error rate-based similarity score for the selected point cluster and assign the subclass of the special-purpose vehicle based on the error rate-based similarity score exceeding a threshold value.

The processor circuit may be configured to determine that the object belongs to the subclass based on Euclidean similarity being greater than a threshold value.

The processor circuit may be configured to adjust a shape and a heading of a predicted bounding box (P-Box), wherein the P-Box corresponds to the object of the subclass to which the selected point cluster belongs.

According to the present disclosure, a method performed by an apparatus of a vehicle may comprise obtaining, via a sensor of the vehicle, point cloud data associated with an object in a surrounding environment of the vehicle, selecting, from among a plurality of point clusters derived from the point cloud data, a point cluster that satisfies both a location condition and a dimension condition corresponding to a special-purpose vehicle, classifying, based on at least one reference height, the selected point cluster as at least one height-specific point cluster, extracting outer points forming an outer shape of the at least one height-specific point cluster, determining a plurality of height-specific polynomial regression coefficients based on spatial coordinate values of the outer points forming the outer shape of the at least one height-specific point cluster, determining whether the selected point cluster is associated with the object, wherein the object corresponds to the special-purpose vehicle, based on the plurality of height-specific polynomial regression coefficients and based on reference height-specific polynomial regression coefficients associated with the special-purpose vehicle, outputting, based on the determining of whether the selected point cluster is associated with the object, a signal indicating that the object corresponds to the special-purpose vehicle, and controlling, based on the signal, driving of the vehicle.

According to the present disclosure, a vehicle may comprise a sensor configured to obtain point cloud data of an object in a surrounding environment of the vehicle, a driving control circuit configured to control autonomous driving of the vehicle, and a processor circuit configured to determine, based on the po int cloud data, a plurality of point clusters, select, from among the plurality of point clusters, at least one point cluster satisfying both a location condition and a dimension condition corresponding to a special-purpose vehicle, classify, based on a plurality of reference heights measured from a ground surface of the surrounding environment of the vehicle, the selected at least one point cluster into at least one height-specific point cluster, extract outer points outlining the at least one height-specific point cluster and determine lengths associated with the outer points, identify, based on spatial coordinates of the outer points, at least one parameter corresponding to the plurality of reference heights, compare the at least one parameter to at least one reference parameter and compare the lengths to reference lengths, and based on the comparisons, determine that the selected at least one point cluster corresponds to the special-purpose vehicle. The processor circuit may further update, based on the determination, at least one of a bounding box associated with the object or a heading angle associated with the object, output a signal indicating the updated bounding box or heading angle, and control, via the driving control circuit and based on the signa 1, driving of the vehicle.

The processor circuit may be configured to process the point cloud data to remove ground points and cluster remaining points into the plurality of point clusters, divide the at least one height-specific point cluster into a plurality of angular see tors relative to a position of the sensor, and select, as the outer points, nearest points to the position of the sensor within respective angular sectors of the plurality of angular sectors, wherein the at least one parameter comprises a set of polynomial coefficients corresponding to the plurality of reference height s, and wherein the at least one reference parameter comprises reference polynomial coefficients.

The processor circuit may be configured to identify a subclass of the special-purpose vehicle based on the comparisons, wherein the at least one reference parameter comprises a first reference parameter associated with a first type of special-purpose vehicle and a second reference parameter associated with a second type of special-purpose vehicle, and wherein the reference lengths comprises a first reference length associated with the first type of special-purpose vehicle and a second reference length associated with the second type of special-purpose vehicle.

The processor circuit may be configured to determine slope values of the point cloud data at different heights and classify points of the point cloud data, as ground or non-ground, based on the slope values and based on the surrounding environment comprising a tunnel.

The processor circuit may be configured to determine that the selected at least one point cluster corresponds to the special-purpose vehicle based on a dimension satisfying a threshold value, wherein the dimension is determined based on the outer points, and wherein the threshold value is determined based on reference data comprising sets of polynomial-fit values corresponding to outer contours of the object.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an overall system for automatically recognizing an object and controlling a vehicle for the purpose of autonomous driving;

FIG. 2 shows an example of an algorithm for recognizing an object corresponding to a special vehicle by using an autonomous driving sensor and an AI;

FIG. 3A, FIG. 3B, FIG. 3C, and FIG. 3D show examples of a process of finding an outer point from point cloud data;

FIG. 4 shows an example of a method of analyzing the distribution of points including nonlinear characteristics by applying a polynomial regression equation and finding polynomial coefficients;

FIG. 5 shows an example of a method for determining a subclass, to which an object belongs, based on a polynomial regression coefficient table (look-up table);

FIG. 6 shows an example of an applicable outer point length;

FIG. 7 shows an example of an actual case to which a special vehicle recognition system; and

FIG. 8 shows an example of a computing system for autonomous vehicle control and object recognition operations.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, in the present disclosure, term “object” includes substantially the same meaning as “gaegche (in Korean)”, and expressions “object” and “gaegche” are used interchangeably in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICS, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of shape-aware LiDAR regression for special-vehicle recognition) described herein, an operation of the vehicle may be controlled. For example, when outer-point polynomial regression identifies a special vehicle such as a ready-mixed concrete truck, a fire truck, or an ambulance, the autonomous driving control system may automatically lower the driving speed, extend braking time control, or adjust the alarm timing control to account for the special vehicle's size and stopping characteristics. The vehicle control may include various operational controls associated with the vehicle (e.g., autonomous driving control, sensor control, braking control, braking time control, acceleration control, acceleration change rate control, alarm timing control, forward collision warning time control, etc.), and each of these controls may be dynamically modified based on the detected special vehicle's shape-aware LiDAR regression profile.

One or more auxiliary devices (e.g., engine brake, exhaust brake, hydraulic retarder, electric retarder, regenerative brake, etc.) may also be controlled, for example, based on one or more features (e.g., feature of controlling a door of the vehicle) described herein. In particular, according to an example of the present disclosure, the auxiliary devices may be controlled based on a feature of shape-aware LiDAR regression for special-vehicle recognition. For example, when the system recognizes a special vehicle such as a ready-mixed concrete truck, a ladder truck, or an ambulance using outer-point polynomial regression, the engine brake and electric retarder may be automatically adjusted to maintain a safer following distance, the regenerative brake may be activated earlier to slow down more smoothly, or the hydraulic retarder may be selectively engaged to stabilize the vehicle's deceleration under high load conditions.

One or more communication devices (e.g., a modem, a network adapter, a radio transceiver, an antenna, etc.) that are capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc., may also be controlled, for example, based on one or more features (e.g., a feature of shape-aware LiDAR regression for special-vehicle recognition) described herein. For example, when the shape-aware LiDAR regression feature recognizes an emergency vehicle (e.g., ambulance, fire truck, or police car) approaching from behind, the vehicle's communication device may automatically send a V2X message to nearby connected vehicles to alert them of the special vehicle's presence or transmit a priority-lane request to roadside infrastructure. Similarly, when a large construction vehicle is detected in a work zone, the system may increase the frequency or priority of data exchanged with cloud servers to update high-definition maps or warn following vehicles via Bluetooth or ITE connections. In another case, the vehicle may temporarily activate an antenna array to improve reception quality and reduce latency for urgent messages triggered by the detection of a special vehicle.

Minimum risk maneuver (MRM) operation(s) may also be controlled, for example, based on one or more features (e.g., a feature of shape-aware LiDAR regression for special-vehicle recognition) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. For example, when the shape-aware LiDAR regression feature recognizes a ladder truck stopped ahead or an ambulance merging from the shoulder, the system may automatically activate a minimum risk maneuver by slowing the vehicle, increasing the lateral clearance, and steering toward a safer part of the lane to create space for the emergency vehicle. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time (e.g., gradually decelerating to a complete stop, moving to the road shoulder, or switching on hazard lights when a special vehicle is detected).

Biased driving operation(s) may also be controlled, for example, based on one or more features (e.g., a feature of shape-aware LiDAR regression for special-vehicle recognition) described herein. A driving control apparatus may perform a biased driving control. To perform a biased driving operation using the shape-aware LiDAR regression feature, the driving control apparatus may control the vehicle to drive in a lane by maintaining a lateral distance between the position of the center of the vehicle and the center of the lane that is dynamically adjusted when a special vehicle is detected. For example, when the shape-aware LiDAR regression feature recognizes a ready-mixed concrete truck in an adjacent lane (e.g., between 1 m and 2 m reference heights showing a rotating drum), the vehicle may bias its path to stay further from the detected truck even though it remains within its lane. The driving control apparatus may identify or determine a biased target lateral distance for biased driving control (e.g., shifting 0.3 m closer to the opposite lane marker when an ambulance or ladder truck is detected, or reducing the offset when a standard passenger car is detected). A biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, especially when unique vehicle contours are recognized by the shape-aware LiDAR regression feature. For example, during a lane change, the driving control system may bias the lateral distance to keep a safer gap from adjacent special vehicles such as fire trucks, construction vehicles, or buses, considering factors such as the vehicle's speed, road conditions, and/or the presence of obstacles detected in the LiDAR point cloud.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., a feature of shape-aware LiDAR regression for special-vehicle recognition) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.). For example, when the shape-aware LiDAR regression feature identifies a ready-mixed concrete truck ahead, the system may automatically increase the sampling rate of the RADAR and camera sensors to collect more detailed data, activate the emergency brake assistance control sooner, or adjust lane keeping assist control to maintain a greater lateral distance. Likewise, when a ladder truck or ambulance is detected, the vehicle may adaptively reduce its speed and temporarily enable a higher-resolution LiDAR scan mode to refine the outer-point detection, thereby improving special-vehicle recognition and overall safety.

An autonomous driving level and/or autonomous driving activation/deactivation may also be controlled, for example, based on one or more features (e.g., a feature of shape-aware LiDAR regression for special-vehicle recognition) described herein. A driving control apparatus may perform an autonomous driving level control (e.g., automatically lowering the autonomous driving level from Level 4 to Level 2 when a special vehicle is detected, or temporarily deactivating autonomous driving when an unusual ladder truck is encountered, etc.) or cause deactivation of an autonomous driving operation. For example, when the shape-aware LiDAR regression feature identifies a ready-mixed concrete truck ahead (e.g., a large rotating drum detected between reference heights of 1 m and 2 m), the system may automatically reduce the autonomous driving level to require more frequent driver input. By changing the required user attentiveness, the driver may be required to place his/her hands on the driving wheel more often (e.g., at least once in a threshold time period, such as five seconds, 30 seconds, 1 minute, etc.) when the detected object is a special vehicle such as a fire truck, ambulance, or ready-mixed concrete truck. By changing the required user attentiveness, the driver may be required to look ahead more often (e.g., at least once in a threshold time period, such as five seconds, 30 seconds, 1 minute, etc.) when the detected object presents a non-standard contour. By changing the autonomous driving level based on the recognition result of the shape-aware LiDAR regression feature, one or more video contents may not be displayed on a display of the vehicle (e.g., disabling entertainment video to keep the driver alert when a special vehicle is detected).

According to the present disclosure, an apparatus and method are provided for reliably recognizing a special vehicle object using a sensor and an artificial intelligence (AI) model. The apparatus may include a processor, a sensor (e.g., LiDAR), and a memory storing point cloud data and AI models. The processor circuit may be configured to pre-process raw LiDAR data to remove ground noise and cluster points that satisfy location and dimension conditions corresponding to a special vehicle. The processor circuit may further classify the clustered points into at least one height-specific point cluster, extract outer points outlining each cluster at multiple reference heights, and determine height-specific polynomial regression coefficients from the spatial coordinates of the outer points. By comparing the coefficients and outer-point lengths to a height-specific polynomial regression coefficient table (e.g., look-up table) reflecting the unique shapes of special vehicles, the processor circuit may determine whether the point cluster corresponds to a special vehicle and, as needed, identify a subclass such as a fire truck, ladder truck, ambulance, or ready-mixed concrete truck. Based on this determination, the processor circuit may correct or update predicted bounding boxes, heading angles, or other tracking parameters to improve object recognition accuracy and orientation estimation of special vehicles, thereby enhancing the safety and reliability of autonomous driving of the vehicle.

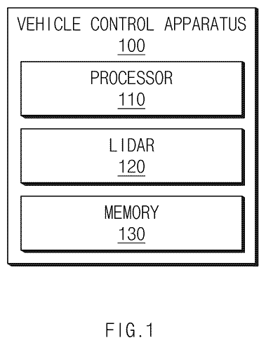

FIG. 1 shows an example of an overall system for automatically recognizing an object and controlling a vehicle for the purpose of autonomous driving, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a LiDAR 120, and a memory 130. The processor 110, the LiDAR 120, or the memory 130 may be electronically and/or operably coupled with each other by an electronical component including a communication bus.

Hereinafter, the fact that pieces of hardware are coupled operably may include the fact that a direct and/or indirect connection between pieces of hardware is established by wired and/or wirelessly such that second hardware is controlled by first hardware among the pieces of hardware.

Although the pieces of hardware are shown in different blocks, an example is not limited thereto. For example, some of the pieces of hardware in FIG. 1 may be included in a single integrated circuit including a system on chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core (e.g., depending on the computational complexity of perception models, route planning, or control logic, etc.).

According to an example, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit”.

The vehicle control apparatus 100 according to an example may include a depth sensor for detecting an external object. For example, the depth sensor for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., combining LiDAR and RADAR to improve robustness in low-visibility conditions, etc.). Hereinafter, for convenience of description, descriptions will focus on LiDAR.

The vehicle control apparatus 100 according to an example may include the LiDAR 120 that obtains a plurality of points based on a pulse laser signal. For example, the LiDAR 120 may obtain datasets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulse laser signal emitted from the LiDAR 120 being reflected and returned by the surrounding object (e.g., a nearby vehicle, a pedestrian, a tree, or a building, etc.).

For example, the LiDAR 120 may obtain datasets for expressing an external object in the space defined by an x-axis, a y-axis, and a z-axis based on a pulse laser signal reflected from surrounding objects. For example, the LiDAR 120 may obtain datasets including a plurality of points in the space, which is formed by the x-axis, the y-axis, and the z-axis, based on receiving the pulse laser signal at a designated period (e.g., every 100 milliseconds, every sensor frame, or at a refresh rate of 10 Hz, etc.). For example, the plurality of points may include points representing an external object within a three-dimensional virtual coordinate system. The three-dimensional virtual coordinate system may include at least one of a vehicle coordinate system, or a LiDAR coordinate system, or any combination thereof. However, an example of the three-dimensional virtual coordinate system is not limited to those described above (e.g., it may include a world coordinate system or a map-based coordinate system, etc.).

The memory 130 of the vehicle control apparatus 100 according to an example may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., depending on cost, size, write endurance, or access speed, etc.).

One or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application” (e.g., an object detector, a SLAM module, or a LiDAR segmentation engine, etc.).

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) executable by the processor 110 of the vehicle control apparatus 100 (e.g., a binary executable file, or a compiled library, etc.).

For example, the memory 130 may include a first neural network model for detecting an object. For example, the memory 130 may include a second neural network model for outputting the types of the plurality of points obtained by the LiDAR 120, and/or scores of the plurality of points (e.g., object class scores or distance likelihoods, etc.).

In an example, the processor 110 may obtain at least one of a first virtual box representing a target object, or a first class representing the type of the target object, or any combination thereof based on the plurality of points obtained through the LiDAR 120 and the first neural network model stored in the memory 130.

For example, the processor 110 may obtain at least one of the first virtual box representing the target object, or the first class representing the type of the target object, or any combination thereof based on inputting the plurality of points to the first neural network model. For example, the first neural network model may include an object detection model (e.g., a 3D bounding box detector or a center-based detection network, etc.). For example, the target object may include an external object placed within a specified distance from the vehicle control apparatus 100 (or a host vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include a plurality of types for classifying the target object. For example, the type of the target object may include at least one of a first type representing the ground, or a second type representing a type different from the ground, or any combination thereof. The type of the target object is not limited to the examples described above. For example, the type of the target object may include, but is not limited to, at least one of a third type representing a person, or a fourth type representing a vehicle, or any combination thereof (e.g., a bicycle, a traffic cone, a tunnel wall, or a construction sign, etc.).

In an example, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model (e.g., a range-view CNN, a point-based classifier, or a sparse voxel network, etc.).

For example, the second neural network model may include a neural network model for obtaining the types of the plurality of points and scores of the plurality of points (e.g., softmax outputs, probability heatmaps, or class activation scores, etc.).

For example, the processor 110 may obtain the first partial points corresponding to at least part of the target object among the plurality of points based on inputting the plurality of points to the second neural network model. For example, the processor 110 may identify the types of the plurality of points based on inputting the plurality of points to the second neural network model. For example, the processor 110 may obtain the first partial points corresponding to at least part of the target object among the plurality of points based on the type of each of the plurality of points (e.g., classifying some points as belonging to a vehicle, pedestrian, or roadside object, etc.).

In an example, the processor 110 may perform a first specified algorithm on the plurality of points. For example, the processor 110 may perform the first specified algorithm for classifying the type of each of the plurality of points on the plurality of points. For example, the processor 110 may classify second partial points corresponding to a specified type among the plurality of points. For example, the specified type may include a type representing the ground (e.g., pavement, crosswalks, or flat surfaces, etc.).

For example, on the basis of performing the first specified algorithm on the plurality of points, the processor 110 may obtain (or identify) the first partial points by classifying the second partial points corresponding to the specified type and excluding the second partial points from the plurality of points (e.g., separating above-ground structures from terrain, etc.).

In an example, the processor 110 may obtain at least one of a partial class for obtaining the second class, or a score of each of the plurality of points, or any combination thereof based on inputting the plurality of points to the second neural network model. For example, the processor 110 may obtain the partial class and the score of each of the plurality of points based on inputting the plurality of points to the second neural network model. For example, the partial class may include classifying the plurality of points based on an arbitrary type (e.g., tree, vehicle, pedestrian, or unknown, etc.).

For example, the processor 110 may fuse the partial class, the score of each of the plurality of points, and the second partial points (e.g., for joint feature enhancement or confidence weighting, etc.). For example, the processor 110 may perform clustering based on fusing the partial class, the score of each of the plurality of points, and the second partial points. For example, the clustering may include grouping the first partial points corresponding to at least part of the target object (e.g., to generate an instance-level region for bounding box generation, etc.).

For example, the processor 110 may obtain a point cloud for generating a second virtual box based on the first partial points. For example, the processor 110 may obtain the point cloud based on grouping the first partial points (e.g., using spatial proximity, density thresholding, or Density-Based Spatial Clustering of Applications with Noise (DBSCAN), etc.).

For example, the processor 110 may generate the second virtual box, which is different from the first virtual box and represents the target object, based on the point cloud. For example, the second virtual box may include a box including at least some of the first partial points (e.g., tightly fitted to the object's spatial extent, etc.).

For example, the processor 110 may identify a heading direction indicating a traveling direction of the target object based on at least one of the first partial points, or the point cloud, or any combination thereof (e.g., using temporal point shifts or bounding box orientation, etc.).

For example, the processor 110 may identify the location of the second virtual box in the virtual coordinate system based on at least one of the first partial points, or the point cloud, or any combination thereof (e.g., by computing the centroid of the clustered points, using a bounding box anchor, or referencing vehicle-relative coordinates, etc.). For example, the processor 110 may identify the size of the second virtual box based on at least one of the first partial points, or the point cloud, or any combination thereof (e.g., by estimating width, height, and depth based on point dispersion or statistical spread, etc.). For example, the processor 110 may identify the second class based on at least one of the first partial points, or the point cloud, or any combination thereof (e.g., classifying as car, pedestrian, traffic cone, or unknown, etc.). For example, the processor 110 may identify at least one of a heading direction indicating a traveling direction of the target object, a location of a second virtual box in a virtual coordinate system, a size of the second virtual box, or a second class, or any combination thereof based on at least one of the first partial points, or the point cloud, or any combination thereof (e.g., to aid in trajectory prediction, collision risk estimation, or classification confidence, etc.). For example, the processor 110 may identify the heading direction of a bounding box based on at least one of the first virtual box, the first class, the heading direction of the second virtual box, the location of the second virtual box, the size of the second virtual box, or the second class, or any combination thereof (e.g., by tracking box orientation over time, using direction vectors, or aligning with lane markings, etc.). For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof (e.g., using Kalman filtering, relative coordinate mapping, or GPS reference data, etc.). For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof (e.g., refining classification using fusion from multiple frames, object hierarchy rules, or semantic context, etc.). For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., for generating object tracks, scene graphs, or vehicle control cues, etc.).

For example, the processor 110 may assign a first identifier to the second virtual box for tracking the second virtual box (e.g., a unique ID based on timestamp, class, or location hash, etc.). For example, the processor 110 may assign a second identifier corresponding to the first identifier to a bounding box (e.g., to maintain identity consistency between detection and tracking outputs, etc.).

For example, the processor 110 may track the bounding box by using the second identifier. For example, the processor 110 may track a target object based on identifying, in a plurality of frames, a plurality of bounding boxes including the bounding box to which the second identifier is assigned (e.g., through temporal association or object re-identification, etc.). For example, because the second identifier is an identifier assigned to the bounding box corresponding to the target object, the processor 110 may track the target object by identifying a plurality of bounding boxes, to which the second identifier is assigned, in a plurality of frames (e.g., over multiple sensor cycles or time steps, etc.).

In an example, the processor 110 may output the bounding box corresponding to the target object based on at least one of the first virtual box, the first class, the first partial points, or the second class, or any combination thereof (e.g., as a hexahedral 3D box, 2D projected box, or directional polygon, etc.). For example, a bounding box may include an example of the target object expressed in a virtual coordinate system in the form of a hexahedron (e.g., defined by eight corner points in 3D space, etc.).

Hereinafter, operations performed by a CPU, a GPU, and/or an NPU included in the processor 110 are briefly described.

In an example, the processor 110 may include at least one of the CPU, the GPU, or the NPU, or any combination thereof. For example, at least one of the GPU, or the NPU, or any combination thereof may obtain the first virtual box and the first class based on the first neural network model (e.g., a region proposal network, transformer-based model, or YOLO-like detector, etc.). For example, at least one of the GPU or the NPU may obtain the first virtual box and the first class. For example, at least one of the GPU, or the NPU, or any combination thereof may obtain a score for each of the plurality of points and a partial class for obtaining the second class based on the second neural network model. For example, at least one of the GPU or the NPU may obtain the score of each of the plurality of points and the partial class for obtaining the second class based on the second neural network model (e.g., probability distributions over semantic labels, etc.). For example, the CPU may classify the second partial points corresponding to a specified type among the plurality of points based on performing the first specified algorithm for classifying the type of each of the plurality of points on the plurality of points (e.g., such as distinguishing ground, non-ground, or noise points, etc.).

As described above, the vehicle control apparatus 100 according to an example may include at least one processor 110. The vehicle control apparatus 100 may accurately detect the target object by detecting the target object by using the at least one processor 110. Furthermore, the vehicle control apparatus 100 may reduce the load on each processor by performing parallel processes (e.g., enabling real-time LiDAR segmentation and object tracking, etc.).

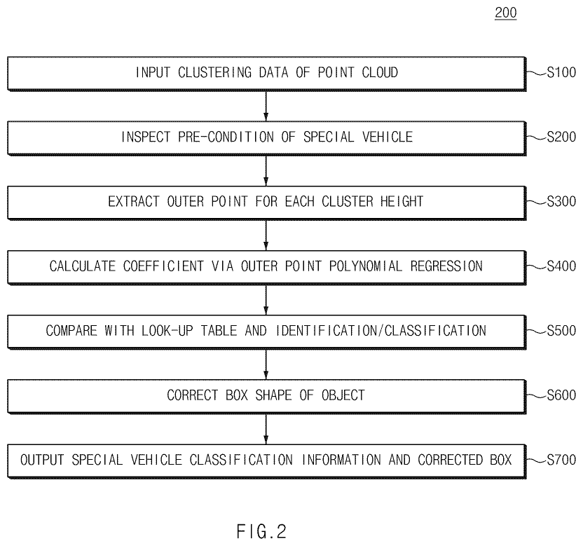

In the meantime, before referring to FIG. 2, for a general understanding of AI object recognition according to an example of the present disclosure, descriptions related to LiDAR-based object recognition is added as follows.

The object recognition process by the LiDAR 120 and the AI module goes through three stages: pre-processing, segmentation, and tracking. For example, AI module may include and execute one or more AI models (e.g., neural networks) for preprocessing, segmentation, and tracking (e.g., detecting road surfaces, identifying vehicle outlines, or following pedestrian movement, etc.).

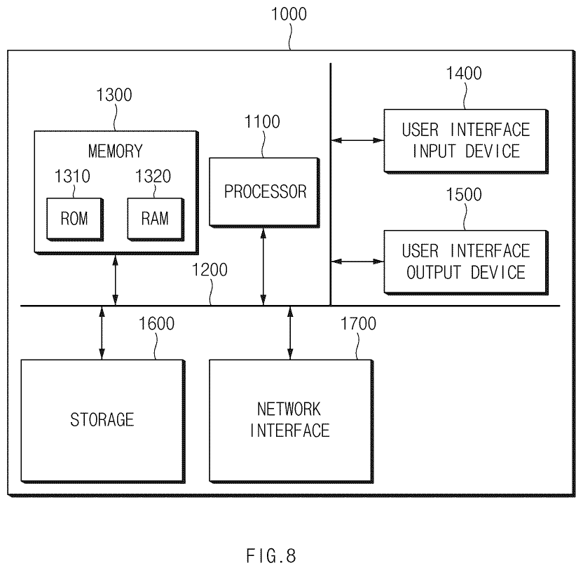

An object recognition system 1000 (see FIG. 8) according to an example of the present disclosure goes through a pre-processing process before executing an object recognition function. The pre-processing may include an operation of removing points forming the ground based on laser sensing data (i.e., raw data not processed) input from the LiDAR 120. Because the laser beam reflected from the ground may be misrecognized as though there is an object on the ground, a process of distinguishing between the ground and non-ground may be performed in the pre-processing stage. As needed, the process may also be performed in the segmentation stage.

For example, in AI object recognition, the pre-processing may be understood as a process in which an image processing tool of the AI module in the processor 110 removes noise from a LiDAR point cloud image and reduces the total number of points being present in the LiDAR point cloud image through a voxel downsampling technique to improve computational efficiency.

For reference, the LiDAR point cloud image may also be displayed in a bird's eye view (BEV) mode. When a LiDAR map is created to resemble the scene as seen through a bird's eye when a bird watches a city center while a bird flies overhead, such LiDAR map is called a BEV image (e.g., top-down views showing roads, vehicles, curbs, or crosswalks, etc.).

In other words, as described above, the LiDAR 120 generates a point for each of the numerous laser signals and calculates a distance to the point, by sending a laser beam out into environments and recording the time interval at which the laser beam is reflected from an object outside the environments and then is returned. The processor 110 may create a real-time LiDAR map of the surrounding environment as a BEV-type 3D map, or as a 2D map as needed (e.g., for simplified planning, navigation, or pedestrian zone detection, etc.), by repeatedly sending out a lot of laser beams in this way.

The lines or areas that appear in black and white on a LiDAR point cloud map are actually composed of countless points (each of the points is generated by the laser beam of the LiDAR 120), which is why the LiDAR sensing image is also called the LiDAR point cloud image. Of course, for example, when an RGB-D (Red, Green, Blue-Depth) sensor and a LiDAR sensor are combined, the LiDAR point cloud image may be recreated in color (e.g., to distinguish road markings, traffic signs, or construction cones, etc.).

It is difficult for humans to perceive objects with a lot of points in the LiDAR point cloud image. However, when comprehensively looking at a point cloud from a BEV perspective or in a method such as a two-dimensional plan, humans may roughly guess what the surroundings of the vehicle currently driving autonomously look like. Furthermore, for example, various types of objects (e.g., vehicles, buses, pedestrians, street trees, traffic signs, or a construction cone, etc.) that are present in the LiDAR point cloud image may be recognized. In an AI image recognition technology, these things or people are called objects. Each object may be classified into classes belonging to a group with specific characteristics, such as a vehicle class or a bus class or the like (e.g., pedestrian class, traffic light class, or barrier class, etc.).

Identifying a class of an object such as a vehicle class, a bus class, and the like in the LiDAR point cloud image requires the help of a deep AI neural network. To find objects in the LiDAR point cloud image through an AI neural network and to identify classes of the objects, AI training needs to be performed first.

For example, a dataset called PANDASET™ includes over 48,000 camera images (mostly taken in the Silicon Valley area in the United States) and over 16,000 LiDAR scan images, which are annotated with 28 classes, including pedestrians, passenger cars, bicycles, construction site signs, and traffic signs (e.g., stop signs, yield signs, or pedestrian crossing signs, etc.).

Moreover, the LiDAR point cloud image may be visualized to suit a user's desired options by using point cloud task tools such as Open3D™. Because the LiDAR 120 is capable of detecting a distance, 3D LiDAR images may be realistically reproduced in visual processing with Open3D™, for example, in a method in which objects farther away are colored in dark blue, and objects closer are colored in light blue (e.g., rendering distant trees in blue and nearby vehicles in bright blue, etc.).

Furthermore, as mentioned above, the original LiDAR image (i.e., raw data) may be pre-processed by applying a technique called voxel (three-dimensional pixel) downsampling to the LiDAR point cloud image. Here, the voxel refers to a cube-shaped 3D pixel. The voxel downsampling is a technique for reducing the number of points in the LiDAR point cloud so as not to require excessive AI calculations while the structure of various objects included in a LiDAR point cloud is maintained.

In the meantime, for example, the LiDAR 120 emits ‘m’ laser beams ‘n’ times during one scan cycle. In this case, scan values of the laser beams that collide with an external object and return form an m×n matrix. Data of the m×n matrix is called a range image. Each point constituting the LiDAR point cloud image includes depth (i.e., range) information, and also includes the intensity, azimuth, and inclination of the returned laser pulse (e.g., reflectivity, return number, or time-of-flight, etc.) and other additional information. For range images, AI training is possible by using large datasets such as Waymo™ Open Dataset (WOD), for example.

In short, range view (RV) is a technique that converts a three-dimensional point cloud into a two to two-and-a-half-dimensional scene, and represents the converted result as a LiDAR three-dimensional map that humans is capable of intuitively understanding like an analog painting instead of a lot of dots (e.g., as a panoramic image showing lane boundaries and obstacles in a simplified layout, etc.). In the range view image, the 3D LiDAR point cloud image includes 2D coordinates. However, the 3D laser-related information (an angle, an inclination, intensity, or the like) recorded when the range image is obtained is not discarded. When one coordinate of one 2D axis is obtained by applying a variable of a width to coordinates (x, y) among coordinates (x, y, z) of the 3D LiDAR image, and the other coordinate of the other 2D axis is obtained by applying a variable of a height and range image information indicating a range (depth) to coordinate (z), a 2D range view image is created (e.g., mapping lateral position to image width and vertical angle or elevation to image height, etc.).

In addition, the AI algorithm according to an example of the present disclosure may include a convolutional neural network (CNN). The CNN is an AI training module frequently used to extract features (or feature points) from image data (e.g., edges, corners, textures, or object outlines, etc.). To this end, there are commercially available datasets composed of tens of thousands of images. Currently, the CNN includes includes a version capable of processing images from 1D to 3D (e.g., 1D for signal patterns, 2D for camera images, or 3D for LiDAR voxel grids, etc.). That is, results from a range view image processing tool are trained by the CNN to perform a function of helping AI accurately recognize an object in an image.

Because an object around an autonomous vehicle is finally recognized by a machine, generation of a ground truth (GT) bounding box on the aforementioned LiDAR map is also an important process in object recognition. In machine learning, the GT is a term used to indicate an original value or an actual value of data to be trained by the AI (e.g., the real position of a pedestrian, car, or traffic cone, etc.). It may be a type of image annotation applied to the LiDAR point cloud image as a bounding box usually with a box-shaped boundary.

That is, to recognize an object, the AI module fetches a label and then groups various objects (e.g., grouping multiple detected vehicles into a vehicle class or pedestrians into a pedestrian class, etc.). Of course, an interval between 3D data points used to output a GT bounding box may also be set. One GT bounding box may be set to include 50 to 1000 LiDAR cloud points (e.g., depending on the object's size or scan density, etc.).

Of course, such the GT annotation is not present in raw data captured by a sensor such as the LiDAR 120 while a vehicle is driving. The processor 110 needs to recognize a target belonging to various classes such as road signs, crosswalks, pedestrians, another vehicle, or a center line, or a guardrail, etc., as an object. The GT annotation is a means used to measure object recognition errors by comparing the object determination results recognized by the AI algorithm of the processor 110 with an actual object and to sometimes evaluate AI performance. The GT bounding box applied to an original image in an annotation form may be set manually by a user, but there are also commercially available GT calculation tools, such as grid-striding (e.g., dividing a space into grid cells and labeling each cell's contents, etc.).

When an AI object recognition module is executed, the predicted bounding box may also be identified. The result recognized by the processor 110 as an object of a specific class from the original image data obtained from the LiDAR sensor 120 is displayed in the shape of another bounding box similar to the GT bounding box. The predicted bounding boxes, unlike GT bounding boxes, are the computational results of autonomous driving AI. The predicted bounding box may match the GT bounding box, but there may be an area that does not match or overlap the GT bounding box at all (e.g., due to sensor noise, occlusion, or misclassification, etc.).

For reference, only the predicted bounding boxes may not definitively determine whether an object of a specific class is actually present at a specific location, and thus the predicted bounding boxes are usually called probability boxes (P-Boxes) or predicted bounding boxes.

For example, segmentation processing performed after pre-processing refers to displaying a specific part of a road (e.g., a traffic light) in red and the rest (an asphalt road) in blue (e.g., for class-based color labeling, etc.). Clustering a point cloud into specific groups and generating P-Box may also be performed at the segmentation stage. For reference, there is also a technique called cluster expansion. Here, an expansion target may include a cluster from a seed point to all points within an epsilon distance (a minimum distance for forming a cluster) (e.g., expanding a group of adjacent car-surface points into a full vehicle object, etc.).

During the segmentation processing, P-Box creation and clustering based on the point cloud are performed. For example, the AI network performing segmentation is used to obtain a point label from the LiDAR sensor 120 (e.g., labeling a point as road, curb, or obstacle, etc.).

To solve a ground recognition error occurring during the segmentation, the present disclosure proposes a “rule-based” ground recognition and label fusion technique. Any of various techniques such as slope-based ground recognition, grid-based ground recognition, or other non-planar-based ground recognition may be applied as the ground recognition algorithm (e.g., for detecting curved ramps, uneven terrain, or multi-elevation surfaces, etc.). However, in an example of the present disclosure, it is proposed that the slope-based ground recognition technique is to be adopted when the ground inside a tunnel is recognized.

For reference, semantic segmentation refers to a task of assigning a unique class label to each point in the point cloud generated by the LiDAR 120. In the LiDAR image processing technology, the semantic segmentation is a technology that finds and uses meaningful information from LiDAR data for object recognition and scene reproduction, which are necessary for implementing autonomous driving (e.g., identifying roads, sidewalks, vehicles, or vegetation, etc.). Various semantic segmentation AI models (e.g., a projection-based method, a point-based method, and a sparse convolution-based method, etc.) may be applied. For example, the semantic segmentation result may be the result of AI computation performed by the processor 110 and NVIDIA DRIVE™ AGX system. With this configuration, for example, various colors may be added to the LiDAR point cloud image (e.g., coloring vehicles in red, pedestrians in yellow, or road surfaces in gray, etc.).

After the segmentation process as above, the LiDAR image goes through a post-processing process. The post-processing refers to converting point cloud data into a 3D map or a model, to extract meaningful information for autonomous driving. The post-processing also includes a process of finally removing noise and errors from a LiDAR point cloud image, recognizing an object such as a vehicle or a pedestrian from the point cloud, and attaching and registering a unique identifier (e.g., for object tracking, localization, or scene mapping, etc.) to point cloud information as necessary.

Next, FIG. 2 shows an example of an algorithm 200 for recognizing an object corresponding to a special vehicle by using an autonomous driving sensor and an AI, according to an example of the present disclosure.

Referring to FIG. 2, in S100, data, which is obtained by clustering a point cloud acquired from an autonomous driving sensor, such as the LiDAR 120, according to the above-described clustering technique is input into an AI module according to an example of the present disclosure (e.g., the AI module may perform object detection, classification, or tracking, etc.). The data, which is obtained by clustering a point cloud acquired from an autonomous driving sensor may include point cluster. For reference, the AI module may be a part of the system 1000 of FIG. 8.

Afterwards, S200 determines whether the point cloud information input in S100 is a target for execution of calculations for a special vehicle. That is, the number of points input from the autonomous driving sensor 120 may be innumerable, and the point cloud obtained by clustering the points may also be too many to compute whether it is a special vehicle (e.g., hundreds of thousands of LiDAR returns per frame).

For this reason, in S200, it is necessary to filter out the target for calculation associated with whether it is a special vehicle, by applying some filtering conditions. For example, S200 is a process that aims to apply the present disclosure to only the object corresponding to a reasonable location and a reasonable dimension (e.g., a vehicle within a lane, parked vehicle, or roadside construction equipment, etc.), in which a special vehicle is determined as being present, and excludes unnecessary objects from the target of the core logic by applying location and dimension conditions in a wide allowable range before applying the core logic of the present disclosure corresponding to the extraction of outer points and polynomial regression.

For example, when two-dimensional (2D) coordinates are used, longitudinal reference (x-axis) and transverse (y-axis) locations of an object, longitudinal reference (vertical) size (i.e., length) and transverse (horizontal) size (i.e., width) of the object, and a ratio of the length/width or width/length of the object may be set under a filtering condition in S200 (e.g., length ≥2 m, width ≤3 m, or ratio between 0.5 and 2.0, etc.).

In detail, for example, if a special vehicle called a ready-mixed concrete truck is identified, if the x-axis coordinate is within a range of [3, 60], the y-axis coordinate is within a range of [−5, 5], the longitudinal length is within a range of [1.5, 4], the width is within a range of [2, 3.2], and a length-to-width ratio is within a range of [0.75, 1.5] (e.g., the unit is ‘m’), a procedure proceeds to S300. Likewise, ladder trucks or fire trucks may have different but predetermined coordinate and dimension ranges (e.g., ladder truck width 2.5-3 m, bus length 5-12 m, etc.). For example, in the case of a ready-mixed concrete truck, due to the special shape of only the ready-mixed concrete truck, a “pre-condition” inspection according to S200 may be made based on the actually measured results indicating that the location and size ranges are in the above-described range.

In S300, an outer point for each cluster height is extracted. That is, in the case of special vehicles, object detection and shape estimation using the LiDAR and the AI are difficult due to their unique shape different from that of other general vehicles such as passenger cars (e.g., vans, sedans, or small trucks, etc.). This causes a decline in object tracking and overall recognition performance of the AI module, and thus measures to compensate for this are necessary. The present disclosure introduces the concept of “outer points” as such the measures.

In the case of the point cluster data input in S100, each cluster includes countless points, and each of the points includes height information recognized by the autonomous driving sensor 120 (e.g., height above ground or above sensor plane, etc.).

Accordingly, for example, in S300, a height-specific point cluster may be divided into a plurality of sections with a certain angle centered on the current location (i.e., the location of a host vehicle) of the autonomous driving sensor 120 (e.g., dividing a space by using a lot of pizza slices with a certain angle, like dividing a 360° field into 0.25° or 1° sectors, like slices of a pizza, etc.), and then a point closest to the autonomous driving sensor 120 in each section may be selected as one of outer points.

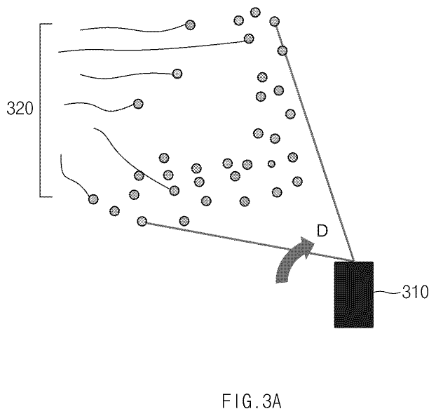

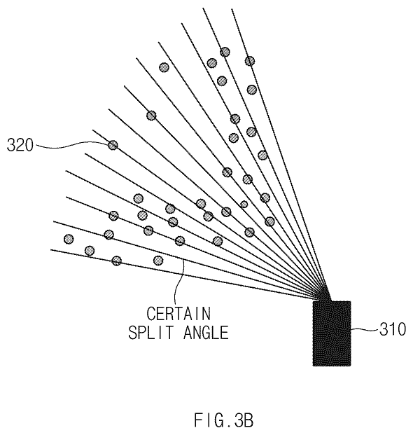

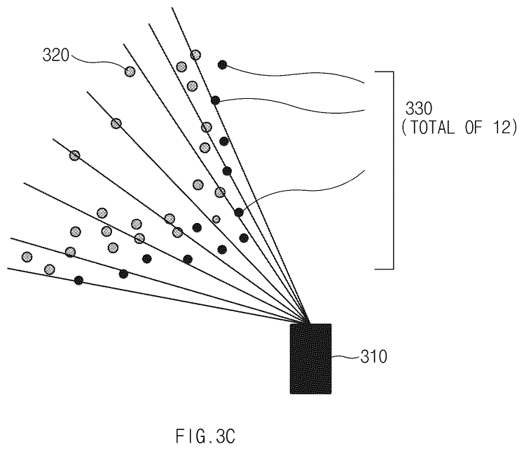

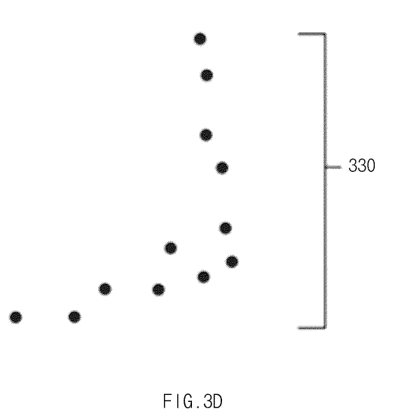

For a clear understanding, descriptions will be given with reference to FIGS. 3A to 3D. FIGS. 3A to 3D show examples of a process of finding an outer point from point cloud data (e.g., showing sector division, point selection, and outer contour formation, etc.), according to an example of the present disclosure.

In FIG. 3A, reference numeral 310 indicates a host vehicle, and the host vehicle 310 is equipped with the autonomous driving sensor 120 (e.g., LiDAR) of FIG. 1. The plurality of points 320 illustrated in FIG. 3A are points clustered in a certain clustering technique, such as a technique based on an Euclidean distance between points (e.g., DBSCAN, k-means, or hierarchical clustering, etc.). Now, the space between the clustered points 320 and the host vehicle 310 is split in a D direction.

That is, referring to FIG. 3B, for example, a constant angle between lines adjacent to each other is 0.25 degrees, and the space may be divided by these lines like small pizza slices, as in FIG. 3B (e.g., 1440 slices for 360° at 0.25°, 360 slices at 1°, etc.). In FIG. 3C, an “outer point 330” is extracted. As may be seen in FIG. 3C, a method of selecting the closest point in each split space unit between the host vehicle 310 and the points 320 may be applied to the extraction criterion. In this case, outer points marked with reference numeral 330 may be obtained as in FIG. 3C. It is important to note that a process of extracting outer points is done on a reference height basis.

In the case of a ready-mixed concrete truck, as the height increases from the wheels, a unique shape of the ready-mixed concrete truck different from those of other vehicles is created. Similarly, buses, container trucks, or ladder trucks may include geometric features that differentiate them from other vehicles starting at a certain height from the wheels (e.g., raised cargo area or extended ladders, etc.).

Accordingly, the present disclosure performs an outer point extraction task as in FIG. 3C in units of a plurality of predetermined “reference heights”, such as 0.5 m, 1 m, 1.25 m, 1.5 m, and 2 m (e.g., additional heights 2.5 m, 3 m, etc. may be used depending on sensor range).

As in FIG. 3D, only the 12 outer points 330 may be identified. In this case, for example, N means 12. Moreover, ‘n’ is used to indicate the first point, the second point, . . . , or the twelfth point (e.g., n=1 for first, n=12 for twelfth, etc.).

Of course, in the case of two-dimensional (2D) coordinates, each of the 12 outer points 330 may include its own coordinate value (x, y), and note that the value is already known to the AI module through the measurement of the LiDAR 120 (e.g., x=3.5 m, y=−2.1 m, etc.).

In addition to the methods illustrated in FIGS. 3A to 3D, other contour measurement techniques, such as a convex hull algorithm or a contour algorithm, may be used in S300 (e.g., Graham scan convex hull, rotating calipers, or active contour models, etc.).

Returning to FIG. 2, the processor 110 and an AI module according to an example of the present disclosure in S400 execute a coefficient extraction process via outer point polynomial regression. In detail, when a spatial coordinate value is two-dimensional, S400 may be executed based on Equation 1 below (e.g., a quadratic regression of y on x, or higher-order polynomial fit, etc.).

yₙ=axₙ²+bxₙ+c [Equation 1]

Here, xₙ is the x-coordinate of the n-th outer point among the total number N (i.e., 12 in the above example) of outer points 330, yₙ is the y-coordinate of the n-th outer point, and each of a, b, and c, which constitute the polynomial regression equation, is a quadratic regression coefficient (e.g., slope coefficient, curvature coefficient, or offset term, etc.).

In S300, the AI module extracts 12 outer points between the i-th reference height and the (i+1)-th reference height (e.g., between 0.5 m and 1 m, between 1 m and 1.5 m, or between 1.5 m and 2 m, etc.), and identifies coordinate value (x, y) for each outer point. Accordingly, it is possible to calculate polynomial coefficients a, b, and c in S400 even if they are not exact values. Of course, the greater the number of outer points (e.g., 20, 30, or 50 points, etc.), the higher the calculation accuracy of the polynomial coefficient.

Here, FIG. 4 is also referenced. FIG. 4 shows an example of a method of analyzing the distribution of points including nonlinear characteristics by applying a polynomial regression equation and finding polynomial coefficients, according to an example of the present disclosure. In FIG. 4, for example, “area 1, 2, . . . , 5” means that the calculation results between reference heights of 0.5 m and 1 m, and between 1 m and the next reference height are shown (e.g., area 1 corresponds to 0.5-1 m, area 2 corresponds to 1-1.5 m, etc.).

Now, in S500, it is possible to determine the upper class to which an object belongs, and as necessary, the lower class, based on reference data (e.g., a polynomial regression coefficient table as a look-up table) according to an example of the present disclosure. For example, when “identification” in S500 described in FIG. 2 is a process of determining only whether object currently being analyzed is a special vehicle, “classification” refers to a process of determining the subclass of a special vehicle among special vehicles (e.g., a fire truck, a ready-mixed concrete truck, a ladder truck, an ambulance, or a bus, etc.).

In S500, the present disclosure proposes a method of applying Equation 2 or Equation 3 as follows.

a_{[i,i}_{₁}_{]}>a_{LUT}_{_{[i,i+1]}}*γ [Equation 2]

Here, a_{[i,i+}_{₁}_{]} is a value calculated based on Equation 1 in a section between the i-th reference height and (i+1)-th reference height. a_{LUT[i,i+1]} is a value according to a polynomial regression coefficient table in the section between the i-th reference height and (i+1)-th reference height. γ is the first hyper-parameter applied to the AI module (e.g., a scaling factor, confidence multiplier, or tuning constant, etc.).

l_{[i,i+1]}>l_{LUT[i,i+1]}*δ [Equation 3]

Here, l_{[i,i+1]} is an l value of the outer point length measured in the section between the i-th reference height and (i+1)-th reference height (e.g., the maximum span or distance between outer points at two successive heights, etc.). l_{LUT[i,i+1]} is an l value according to the polynomial regression coefficient table in the section between the i-th reference height and (i+1)-th reference height. δ is the second hyper-parameter applied to the AI module (e.g., a normalizing constant, threshold adjustment factor, or weighting term, etc.).

For example, Equation 2 means that an object class is determined by placing most of the weight on polynomial coefficient a in the lookup table. For example, in the case of ready-mixed concrete trucks, Equation 2 may be seen as a process of reflecting the actual results indicating that polynomial coefficient a fluctuates wildly in the section between reference heights of 1 m and 2 m (e.g., due to the rotating drum or special upper structure, etc.).

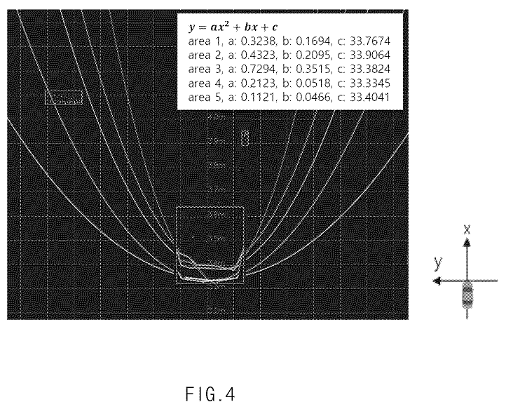

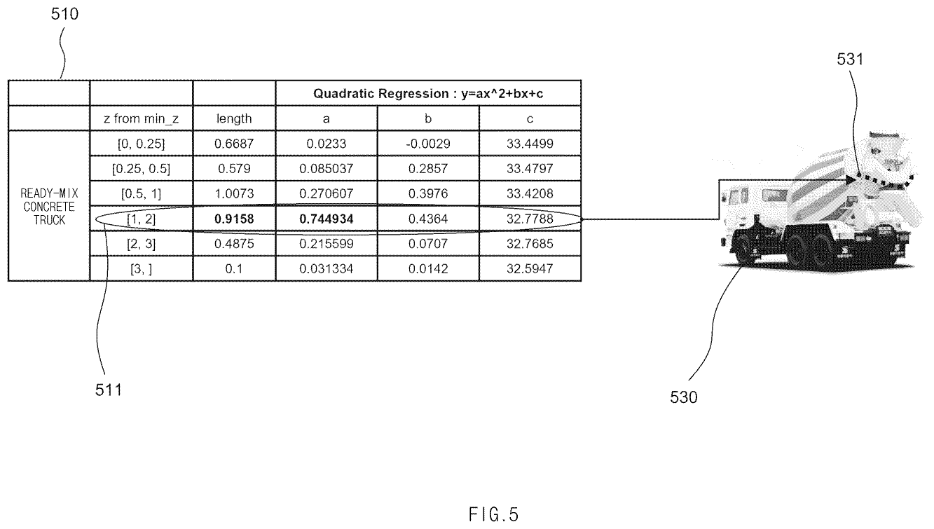

For convenience of description, a description will be given with reference to FIG. 5. FIG. 5 shows an example of a method for determining a subclass, to which an object belongs, based on reference polynomial regression coefficients (e.g., a polynomial regression coefficient table (look-up table)), according to an example of the present disclosure.

In FIG. 5, reference numeral 510 represents reference data (e.g., a look-up table) according to an example of the present disclosure, and reference numeral 530 represents a subclass called a ready-mixed concrete truck belonging to a superclass called a special vehicle. Moreover, a portion marked with a dotted line in reference numeral 531 is in a unique shape of a ready-mixed concrete vehicle capable of being found between reference heights of 1 m and 2 m, and as clearly illustrated in FIG. 5, the distribution of the dotted lines 531 is not linear (e.g., irregular bulge, cavity, or ladder platform, etc.). Therefore, the present disclosure determines that it is most efficient to find the regularity of the outer point distribution by finding a polynomial coefficient through the polynomial regression method according to S400.

In addition, as shown in a fourth column 511 of the look-up table 510, when polynomial coefficient a is at the level of 0.744934 at a point where the height is between 1 m and 2 m (e.g., ±0.05 tolerance, etc.). It may be identified that it may be determined as a ready-mixed concrete truck. Accordingly, if value a calculated in S400 is equal to or close to 0.744934, a vehicle currently being analyzed may be determined as a ready-mixed concrete truck among special vehicles.

For reference, as clearly illustrated in FIG. 5, the look-up table is prepared for each special vehicle type. This means that setting of the reference height may be different depending on whether a vehicle is a fire truck or a ready-mixed concrete truck among the special vehicles, and should be different to identify the correct geometric characteristics of the special vehicle (based on its height from the ground) (e.g., ladders extending above 3 m for a fire truck, drum shape above 1.5 m fora concrete truck, etc.).

Furthermore, an item “length” in the look-up table 510 of FIG. 5 is a parameter called an “outer point length” and corresponds to l in Equation 3.

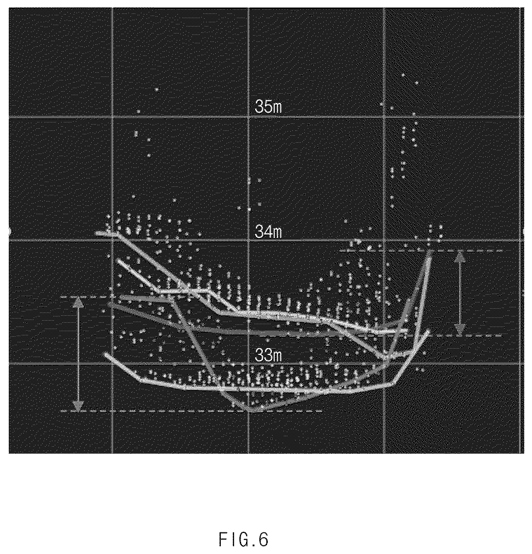

Here, l concept will be described with reference to FIG. 6. FIG. 6 shows an example of an applicable outer point length, according to an example of the present disclosure (e.g., showing how the distance between two selected outer points is measured and compared, etc.).

In FIG. 6, red, green, blue, and purple lines are outlines connecting outer points measured according to a reference height (e.g., outlines at 0.5 m, 1 m, 1.5 m, or 2 m, etc.). In the present disclosure, as illustrated with reference to reference numerals 610 and 620, outer point length l means a difference between the minimum value and the maximum value of the longitudinal reference coordinates among the outer points (e.g., between the furthest front and rearmost outer points, etc.).

Returning to FIG. 5, for example, when the ready-mixed concrete truck 530 is measured in the above-described manner in a section between a height of 1 m and a height of 2 m, outer point length l is approximately 0.9158 (e.g., +0.05 m tolerance, etc.). However, this is in a special shape unique to the ready-mixed concrete truck (e.g., drum section or rear ladder area, etc.). Accordingly, when l value and a value for each reference height section are identified through S100 to S400, even the subclass of special vehicle may be correctly recognized with a very high degree of confidence in S500 (e.g., ≥95% classification confidence, etc.).

For reference, values of various hyper-parameters in the present disclosure may be used as reference values to be applied to machine learning of an AI module according to an example of the present disclosure based on actual experimental results on a special vehicle (e.g., fire truck, ladder truck, ambulance, or bus, etc.) when possible, and thus it is not necessary to discuss the specific values of each hyper-parameter.

Note that for S500, in addition to a method of using Equation 2 or Equation 3 above, there is a method of using Equation 4 or Equation 5 below (e.g., hybrid scoring or similarity scoring, etc.).

(Score_{subsp_a}>α) and (Score_{subsp_l}>β) [Equation 4]

Here, “and” means that both (Score_{subsp_a}>α) condition and (Score_{subsp_l}>β) condition need to be satisfied,

$${Score}_{subsp \_ a} = 1 - \frac{\vert {a}_{{LUT}_{[ i , i + 1 ]}} - {a}_{[ i , i + 1 ]} \vert}{{a}_{{LUT}_{[ i , i + 1 ]}}} , and$$

$${Score}_{subsp \_ l} = 1 - \frac{\vert {l}_{{LUT}_{[ i , i + 1 ]}} - {l}_{[ i , i + 1 ]} \vert}{{l}_{{LUT}_{[ i , i + 1 ]}}} .$$

Subscript subsp refers to one of the subclasses, and each of α and β are the third and fourth hyper-parameters used as threshold values, respectively (e.g., α=0.8, β=0.9, etc.).

$$Euclidean Similarlity = 1 - \sqrt{\sum {( A - B )}^{2}} \qquad [ Equation 5 ]$$

Here, A=[a₁, a₂, . . . , a_{N}] is a polynomial vector, and B=[a_{LUT}_{₁}, a_{LUT}_{₂}, . . . , a_{LUT}_{_{N}}] is a polynomial vector. If the Euclidean similarity Euclidean Similarlity determined based on Equation 5 is greater than the fifth hyper-parameter ρ used as a threshold value when a subclass is determined (e.g., ρ=0.75, 0.8, or 0.9, etc.), it is determined that an object belongs to a specific subclass.

That is, in S400, a process of obtaining ‘a’, ‘b’, and ‘c’ corresponding to coefficients in a second-order polynomial of form y=ax²+bx+c is performed, for example, through quadratic regression (e.g., least-squares fitting, RANSAC fitting, or weighted regression, etc.). In the case of a three-dimension, a matrix may be used based on Equation 6 below.

$$[ \begin{matrix}\sum {x}_{i}^{4} & \sum {x}_{i}^{3} & \sum {x}_{i}^{2} \\ \sum {x}_{i}^{3} & \sum {x}_{i}^{2} & \sum {x}_{i} \\ \sum {x}_{i}^{2} & \sum {x}_{i} & n\end{matrix} ] [ \begin{matrix}\begin{matrix}a \\ b\end{matrix} \\ c\end{matrix} ] = [ \begin{matrix}\sum {x}_{i}^{2} {y}_{i} \\ \sum {x}_{i} {y}_{i} \\ \sum {y}_{i}\end{matrix} ] and \qquad [ Equation 6 ]$$

$$a = \frac{( \sum {x}^{2} y \sum xx ) - ( \sum xy \sum {x}^{2} )}{( \sum xx \sum {x}^{2} ) - {( \sum {x}^{2} )}^{2}}$$

$$b = \frac{( \sum x y \sum {x}^{2} ) - ( \sum {x}^{2} y \sum {x}^{2} )}{( \sum xx \sum {x}^{2} ) - {( \sum {x}^{2} )}^{2}}$$

$$c = \frac{\sum y}{n} - b ( \frac{\sum x}{n} ) - a ( \frac{\sum {x}^{2}}{n} )$$

In this case, because the AI module already identifies a value in S500, Equation 3 indicates a method of determining a subclass by checking a condition of whether a value of a specific reference height section is greater than a value of an LUT (abbreviation for look-up table) that applies hyper-parameter γ (e.g., γ=1.2 or 1.5, etc.). For example, in the case of a ready-mixed concrete truck, there is a special shape in which the outer point length l is longer than a length in a specific height section (e.g., due to a protruding ladder or drum section, etc.), and thus Equation 4 reflects the special shape. Equations 3 and 4 may be applied as an “AND” condition, or in some cases, an “OR” condition may be applied (e.g., for mixed-vehicle environments, etc.).

However, S500 may not be performed by using only Equations 2 and 3. For example, all variables described in Equation 4 are already operable in S500, as is a vector operation in Equation 5 (e.g., to handle high-dimensional similarity across multiple coefficients, etc.).

Equation 4 may refer to a similarity score extraction method based on an error rate. The method extracts a similarity score based on an error rate with a range of [0, 1] for a value of a specific reference height section, extracts a similarity score based on an error rate for l value in the same reference height section, and identifies and classifies an object as, for example, a ready-mixed concrete vehicle (e.g., fire truck or ladder truck, etc.) if the scores exceed hyper-parameter threshold values α, β.

Equation 5 may refer to a Euclidean similarity extraction method. The method replaces a value of all height regions with vector A and vector B, and then executes a L1 normalization process such that the element sum of each vector becomes 1. Afterwards, if the Euclidean similarity value between high-dimensional vectors exceeds hyper-parameter threshold value ρ, the method identifies and classifies an object as, for example, a ready-mixed concrete vehicle (e.g., or other special vehicles depending on LUT type, etc.). In this case, it is possible to extract general regression similarity without being limited to a specific special vehicle or a specific height section. In addition, depending on situations, Euclidean similarity using l value may also be utilized as necessary (e.g., to refine classification confidence, etc.).

The reason that the present disclosure proposes various mathematical approaches as described above is simple. The reason is that AI object recognition performance may be further improved depending on whether class classification is performed from a cognitive perspective or whether class classification is performed from a statistical perspective, when there is a clear identification condition determined by human based on the type of special vehicle (e.g., ladder truck vs. bus vs. ambulance, etc.).

For example, the Euclidean similarity between a typical L-shape vehicle object and a ready-mixed concrete truck LUT is 0.6111; the Euclidean similarity between a typical vehicle rear object and a ready-mixed concrete truck LUT is 0.542; and the Euclidean similarity between a ready-mixed concrete truck object and a ready-mixed concrete truck LUT is 0.7955 (e.g., indicating much higher similarity for the correct subclass, etc.). Accordingly, utilizing these measurement results may significantly improve the recognition reliability of AI objects (e.g., reduce false positives or false negatives, etc.).

Returning to FIG. 2, the algorithm 200 according to an example of the present disclosure corrects a P-Box shape (and heading) of the object in S600 (e.g., bounding box orientation or position adjustment, etc.).

That is, if a special vehicle is identified in S500, the correction of the existing detected box (i.e., P-Box) is performed in consideration of its shape and location. If a special shape existing at the front or rear side of the special vehicle is identified, the front or rear side of the vehicle is identified as an object's main plane of interest (e.g., fire truck ladder front, concrete truck drum rear, etc.). When the location and size of the object are considered together, it may be determined whether the heading angle of the object box needs to face forward. For example, the heading angle facing forward means that the heading angle of the box is 0° (e.g., aligned with lane direction, etc.).

In particular, if there is a special shape at the front or rear side of a special vehicle, the look-up table of the corresponding special vehicle may be pre-analyzed and defined with respect to objects with a heading angle of 0° to reflect the special shape of the plane of interest. Accordingly, in S600, special vehicles with a unique shape in the front or rear side that are identified due to high similarity with the look-up table may correct the heading angle of a box to 0° in consideration of the location and size of the object together (e.g., apply automatic reorientation of bounding box, etc.). In this case, this means that a transverse location of an object is located in the same lane as the host vehicle when the location of the object is considered. For example, in consideration of road conditions, the value may be set as a value satisfying the condition that the center transverse location of the object is (−1.75<y<1.75) (e.g., lane width 3.5 m, etc.).

In the meantime, this means that the longitudinal size is smaller than the original longitudinal length of a vehicle when the size of an object is considered. The reason is that point clusters on the side are not sufficiently recognized when only the rear of the vehicle object is illuminated, and thus the longitudinal size of a point cloud may be smaller than the original length (e.g., 70% or less of nominal length, etc.). The value may vary depending on types of special vehicles and may be set to a value of approximately 70% of the original vehicle length (i.e., longitudinal size <vehicle length*0.7).

Also, in this case, when the heading angle of the existing box is already at a level similar to 0°, correction according to S600 is not performed. For example, only if it includes a large value of 10° or more, the present disclosure may be implemented such that correction in S600 is performed (e.g., avoid unnecessary minor corrections, etc.).

As needed, because there is a problem with box shape information of an object, feedback may be provided to a box shape detection device to precisely detect a box shape again, or an algorithm of extracting a precise object heading angle by using outer points may be performed separately (e.g., iterative bounding box refinement or heading estimation module, etc.).

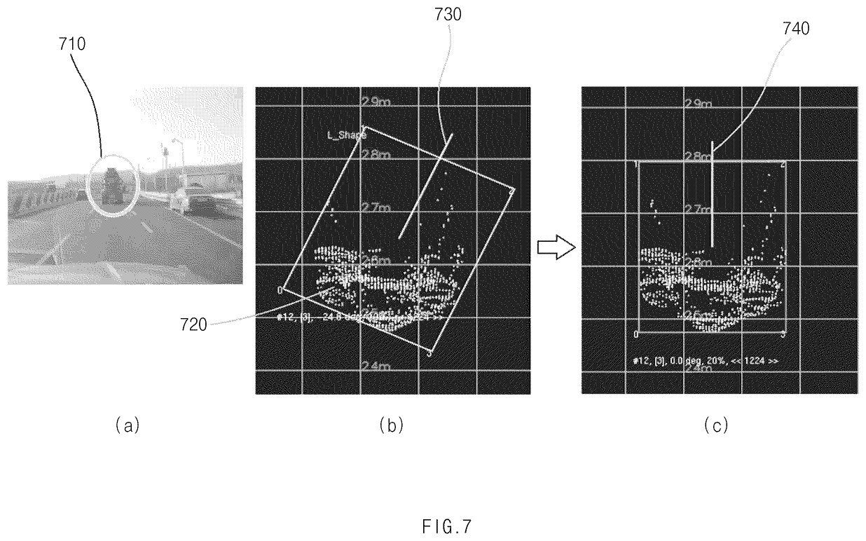

FIG. 7 shows an example of an actual case to which a special vehicle recognition system according to an example of the present disclosure is applied.

(a) in FIG. 7 shows a ready-mixed concrete vehicle 710 captured on a road (e.g., urban lane, highway ramp, or intersection, etc.). (b) in FIG. 7 shows heading and P-Box 730 for the corresponding ready-mixed concrete vehicle before S600 is applied. Here, numerous points 720 are a point cloud measured by the LiDAR 120 (e.g., tens of thousands of returns per scan frame, etc.). (c) in FIG. 7 shows heading and P-Box 740 after S600 is applied (e.g., corrected bounding box and updated heading angle, etc.).

FIG. 8 shows an example of a computing system 1000 for autonomous vehicle control and object recognition operations, according to an example of the present disclosure.

Referring to FIG. 8, the computing system 1000 may include at least one processor 1100, a memory 1300, a user interface input device 1400, a user interface output device 1500, storage 1600, and a network interface 1700, which are connected with each other via a bus 1200 (e.g., PCIe, CAN, or Ethernet, etc.).

The processor 1100 may be a central processing unit (CPU) or a semiconductor device that processes instructions stored in the memory 1300 and/or the storage 1600 (e.g., microcontroller, digital signal processor, or system-on-chip, etc.). Each of the memory 1300 and the storage 1600 may include various types of volatile or nonvolatile storage media. For example, the memory 1300 may include a read only memory (ROM) and a random access memory (RAM) (e.g., DRAM, SRAM, or LPDDR, etc.).

Accordingly, the operations of the method or algorithm described in connection with the examples disclosed in the specification may be directly implemented with a hardware module, a software module, or a combination of the hardware module and the software module, which is executed by the processor 1100 (e.g., FPGA acceleration, GPU-based AI inference, or hybrid CPU/GPU pipelines, etc.). The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM) (e.g., SD card, USB drive, or network-attached storage, etc.).

The storage medium may be coupled to the processor 1100. The processor 1100 may read out information from the storage medium and may write information in the medium. Alternatively, the storage medium may be integrated with the processor 1100 (e.g., as embedded flash or on-chip memory, etc.). The processor and storage medium may be implemented with an application specific integrated circuit (ASIC) (e.g., a custom AI accelerator chip, etc.). The ASIC may be provided in a user terminal (e.g., an autonomous vehicle control unit, roadside unit, or mobile robot, etc.). Alternatively, the processor and storage medium may be implemented with separate components in the user terminal (e.g., discrete CPU and SSD modules, etc.).

According to an example of the present disclosure, the first example of the present disclosure relates to a system for recognizing an object corresponding to a special vehicle by using an autonomous driving sensor and an artificial intelligence (AI) module. That is, the system includes a processor equipped with an object recognition module that recognizes an object placed in a surrounding environment from data input from the autonomous driving sensor as a part of the AI module, and a memory that stores the point cloud data. The AI module performs a first step of selecting a point cluster, which satisfies a location condition and a dimension condition corresponding to the special vehicle, from among a plurality of point clusters input from the autonomous driving sensor, a second step of classifying the selected point cluster into at least one or more height-specific point clusters depending on at least one or more reference heights, and extracting outer points, which are points forming an outer shape of the height-specific point cluster, as a unit of the height-specific point cluster, a third step of calculating a plurality of height-specific polynomial regression coefficients based on spatial coordinate values of the outer points belonging to the height-specific point cluster, and a fourth step of determining whether the selected point cluster is associated with an object corresponding to the special vehicle, depending on the calculated height-specific polynomial regression coefficients and a height-specific polynomial regression coefficient table (look-up table) applied to the special vehicle.

In the case of the AI-based special vehicle object recognizing system according to the second example of the present disclosure, the location condition is a two-dimensional (2D) or three-dimensional (3D) coordinate condition, and the dimensional condition is a length of the object being the special vehicle, a width of the object, and a ratio between the length and the width of the object.

In the case of the AI-based special vehicle object recognizing system according to the third example of the present disclosure, the second step includes dividing the height-specific point cluster into a plurality of sections with a certain angle centered on a current location of the autonomous driving sensor and then selecting a point closest to the autonomous driving sensor as one of the outer points in each section.

In the case of the AI-based special vehicle object recognizing system according to the fourth example of the present disclosure, the third step is executed according to Equation 1 when the spatial coordinate value is two-dimensional.

yₙ=axₙ²+bxₙ+c [Equation 1]

Here, xₙ is the x-coordinate of the n-th outer point among the total number N of outer points, yₙ is the y-coordinate of the n-th outer point, and each of a, b, and c, which constitute the polynomial regression equation, is a quadratic regression coefficient.

In the case of the AI-based special vehicle object recognizing system according to the fifth example of the present disclosure, the determining in the fourth step is determined by the coefficient a according to Equation 2.

a_{[i,i}_{₁}_{]}>a_{LUT}_{_{[i,i+1]}}*γ [Equation 2]

Here, a_{[i,i+}_{₁}_{]} is a value calculated based on Equation 1 in a section between the i-th reference height and (i+1)-th reference height. a_{LUT[i,i+1]} is a value according to a polynomial regression coefficient table in the section between the i-th reference height and (i+1)-th reference height. γ is the first hyper-parameter applied to the AI module.

In the case of the AI-based special vehicle object recognizing system according to the sixth example of the present disclosure, the fourth step is executed by applying Equation 3 to outer point length l, which is a longitudinal distance between an outer point with the minimum longitudinal location and an outer point with the maximum longitudinal location among the outer points extracted in the unit of the height-specific cluster in the second step.

l_{[i,i+1]}>l_{LUT[i,i+1]}*δ [Equation 3]

Here, l_{[i,i+1]} is l value of the outer point length measured in the section between the i-th reference height and (i+1)-th reference height. l_{LUT[i,i+1]} is l value according to the polynomial regression coefficient table in the section between the i-th reference height and (i+1)-th reference height. δ is the second hyper-parameter applied to the AI module.

In the case of the AI-based special vehicle object recognizing system according to the seventh example of the present disclosure, the AI module further performs a fifth step of determining a subclass in which the selected point cluster belongs to a class of the special vehicle.

In the case of the AI-based special vehicle object recognizing system according to the eighth example of the present disclosure, the fifth step includes determining the object belonging to the subclass if Equation 4 is satisfied.

(Score_{subsp_a}>α) and (Score_{subsp_l}>β) [Equation 4]

Here, “and” means that both (Score_{subsp_a}>α) condition and (Score_{subsp_l}>β) condition need to be satisfied,

$${Score}_{subsp \_ a} = 1 - \frac{\vert {a}_{{LUT}_{[ i , i + 1 ]}} - {a}_{[ i , i + 1 ]} \vert}{{a}_{{LUT}_{[ i , i + 1 ]}}} , and$$

$${Score}_{subsp \_ l} = 1 - \frac{\vert {l}_{{LUT}_{[ i , i + 1 ]}} - {l}_{[ i , i + 1 ]} \vert}{{l}_{{LUT}_{[ i , i + 1 ]}}} .$$

Subscript subsp refers to one of the subclasses, and each of α and β are the third and fourth hyper-parameters used as threshold values, respectively.

In the case of the AI-based special vehicle object recognizing system according to the ninth example of the present disclosure, the fifth step includes determining the object belonging to the subclass if Euclidean similarity Euclidean Similarlity determined by Equation 5 is greater than the fifth hyper-parameter ρ used as a threshold value,

$$Euclidean Similarlity = 1 - \sqrt{\sum {( A - B )}^{2}} \qquad [ Equation 5 ]$$

Here, A=[a₁, a₂, . . . , a_{N}] is a polynomial vector, and B=[a_{LUT}_{₁}, a_{LUT}_{₂}, . . . , a_{LUT}_{_{N}}] is a polynomial vector.

In the case of the AI-based special vehicle object recognizing system according to the tenth example of the present disclosure, the AI module further performs a sixth step of correcting a shape and a heading of a P-Box corresponding to an object of the subclass to which the selected point cluster belongs.

According to an example of the present disclosure, an AI-based special vehicle object recognizing method for recognizing an object corresponding to a special vehicle by using an autonomous driving sensor and an AI module includes a first step of selecting, by the AI module, a point cluster, which satisfies a location condition and a dimension condition corresponding to the special vehicle, from among a plurality of point clusters input from the autonomous driving sensor, a second step of classifying the selected point cluster into at least one or more height-specific point clusters depending on at least one or more reference heights, and extracting outer points, which are points forming an outer shape of the height-specific point cluster, as a unit of the height-specific point cluster, a third step of calculating a plurality of height-specific polynomial regression coefficients based on spatial coordinate values of the outer points belonging to the height-specific point cluster, and a fourth step of determining whether the selected point cluster is associated with an object corresponding to the special vehicle, depending on the calculated height-specific polynomial regression coefficients and a height-specific polynomial regression coefficient table (look-up table) applied to the special vehicle.

The above description is merely an example of the technical idea of the present disclosure, and various modifications and variations may be made by one skilled in the art without departing from the essential characteristics of the present disclosure.

Accordingly, examples of the present disclosure are intended not to limit but to explain the technical idea of the present disclosure, and the scope and spirit of the present disclosure are not limited by the above examples. The scope of protection of the present disclosure should be construed according to the attached claims, and all equivalents thereof should be construed as being included within the scope of the present disclosure.

As discussed above, the present disclosure proposes a new system for recognizing an object corresponding to a special vehicle using an autonomous driving sensor and an AI through the first to eleventh examples, and a method thereof. In particular, according to an example of the present disclosure, the AI module is configured to perform (i) a first step of selecting a point cluster, which satisfies a location condition and a dimension condition corresponding to the special vehicle, from among a plurality of point clusters input from the autonomous driving sensor, (ii) a second step of classifying the selected point cluster into at least one height-specific point cluster based on at least one reference height, and extracting outer points, which are points forming an outer shape of the height-specific point cluster, as units of the height-specific point cluster, (iii) a third step of calculating a plurality of height-specific polynomial regression coefficients based on spatial coordinate values of the outer points belonging to the height-specific point cluster, and (iv) a fourth step of determining whether the selected point cluster is associated with an object corresponding to the special vehicle, based on the calculated height-specific polynomial regression coefficients and a height-specific polynomial regression coefficient table (look-up table) applied to the special vehicle.

That is, the present disclosure is mainly used for identification and classification of special vehicles by extracting polynomial coefficients through outer point polynomial regression. In particular, a polynomial regression coefficient table or look-up table reflecting the unique shape of each special vehicle is constructed through data analysis, and the probability of matching the results predicted by the autonomous driving sensor and the AI with actual special vehicles is significantly improved by utilizing the polynomial regression coefficient table or the look-up table.

It is expected that increasing the recognition accuracy of a special vehicle according to an example of the present disclosure may not only improve the safety of autonomous driving, but also enhance the overall object recognition performance of the autonomous driving sensor (e.g., reduce false positives, improve tracking stability, or speed up classification, etc.).

Besides, through the detailed description of the present disclosure and the attached drawings, those skilled in the art may understand various effects other than the effects described above from the present disclosure.

Hereinabove, although the present disclosure has been described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle, the apparatus comprising:
a sensor configured to obtain point cloud data associated with an object in a surrounding environment of the vehicle;
a memory configured to store the point cloud data; and
a processor circuit configured to:
select, from among plurality of point clusters derived from the point cloud data, a point cluster, which satisfies both a location condition and a dimension condition corresponding to a special-purpose vehicle,
classify, based on at least one reference height, the selected point cluster as at least one height-specific point cluster,
extract outer points, which are points forming an outer shape of the at least one height-specific point cluster,
determine a plurality of height-specific polynomial regression coefficients, based on spatial coordinate values of the outer points forming the outer shape of the at least one height-specific point cluster,
determine whether the selected point cluster is associated with the object, wherein the object corresponds to the special-purpose vehicle, based on the plurality of height-specific polynomial regression coefficients and based on reference height-specific polynomial regression coefficients associated with the special-purpose vehicle,
output, based on the determination of whether the selected point cluster is associated with the object, a signal indicating that the object corresponds to the special-purpose vehicle, and
control, based on the signal, driving of the vehicle.

2. The apparatus of claim 1, wherein the location condition comprises a two-dimensional (2D) or three-dimensional (3D) coordinate condition, and wherein the dimension condition comprises at least one of:
a length of the object,
a width of the object, or
a ratio between the length and the width of the object.

3. The apparatus of claim 1, wherein the processor circuit is configured to:
divide the at least one height-specific point cluster into a plurality of angular sections defined relative to a current location of the sensor, and
select, as one of the outer points, a point closest to the current location of the sensor within each respective angular section of the plurality of angular sections.

4. The apparatus of claim 1, wherein the processor circuit is configured to apply quadratic regression to two-dimensional coordinate values of the outer points to determine second-order polynomial coefficients.

5. The apparatus of claim 4, wherein the processor circuit is configured to determine whether the selected point cluster is associated with the object, based on a value obtained from a square root of one of the second-order polynomial coefficients.

6. The apparatus of claim 1, wherein the processor circuit is configured to recognize the object as the special-purpose vehicle based on a length measured in a section between adjacent reference heights exceeding a threshold value,
wherein the length is defined as a longitudinal distance between a first outer point with a minimum longitudinal location and a second outer point with a maximum longitudinal location,
wherein the first outer point and the second outer point are among the outer points forming the outer shape of the at least one height-specific point cluster,
wherein the threshold value is based on a product of a reference length and a predetermined parameter,
wherein the reference length is based on the reference height-specific polynomial regression coefficients, and
wherein the reference height-specific polynomial regression coefficients are in the section between the adjacent reference heights.

7. The apparatus of claim 1, wherein the processor circuit is configured to determine a subclass of the special-purpose vehicle to which the selected point cluster belongs, and wherein the special-purpose vehicle has an irregular body shape different from body shapes of passenger vehicles.

8. The apparatus of claim 7, wherein the processor circuit is configured to:
determine an error rate-based similarity score for the selected point cluster, and
assign the subclass of the special-purpose vehicle, based on the error rate-based similarity score exceeding a threshold value.

9. The apparatus of claim 7, wherein the processor circuit is configured to determine that the object belongs to the subclass, based on Euclidean similarity being greater than a threshold value.

10. The apparatus of claim 7, wherein the processor circuit is configured to adjust a shape and a heading of a predicted bounding box (P-Box), wherein the P-Box corresponds to the object of the subclass to which the selected point cluster belongs.

11. A method performed by an apparatus of a vehicle, the method comprising:
obtaining, via a sensor of the vehicle, point cloud data associated with an object in a surrounding environment of the vehicle;
selecting, from among a plurality of point clusters derived from the point cloud data, a point cluster, which satisfies both a location condition and a dimension condition corresponding toa special-purpose vehicle;
classifying, based on at least one reference height, the selected point cluster as at least one height-specific point cluster;
extracting outer points, which are points forming an outer shape of the at least one height-specific point cluster;
determining a plurality of height-specific polynomial regression coefficients, based on spatial coordinate values of the outer points forming the outer shape of the at least one height-specific point cluster;
determining whether the selected point cluster is associated with the object, wherein the object corresponds to the special-purpose vehicle, based on the plurality of height-specific polynomial regression coefficients and based on reference height-specific polynomial regression coefficients associated with the special-purpose vehicle;
outputting, based on the determining of whether the selected point cluster is associated with the object, a signal indicating that the object corresponds to the special-purpose vehicle; and
controlling, based on the signal, driving of the vehicle.

12. The method of claim 11, wherein the location condition comprises a two-dimensional (2D) or three-dimensional (3D) coordinate condition, and wherein the dimension condition comprises at least one of:
a length of the object,
a width of the object, or
a ratio between the length and the width of the object.

13. The method of claim 11, wherein the classifying of the selected point cluster comprises:
dividing the at least one height-specific point cluster into a plurality of angular sections defined relative to a current location of the sensor; and
selecting, as one of the outer points, a point closest to the current location of the sensor within each respective angular section of the plurality of angular sections.

14. The method of claim 11, wherein the determining of the plurality of height-specific polynomial regression coefficients comprises:
applying quadratic regression to two-dimensional coordinate values of the outer points to determine second-order polynomial coefficients.

15. The method of claim 14, wherein the determining of whether the selected point cluster is associated with the object is based on a value obtained from a square root of one of the second-order polynomial coefficients.

16. A vehicle comprising:
a sensor configured to obtain point cloud data of an object in a surrounding environment of the vehicle;
a driving control circuit configured to control autonomous driving of the vehicle; and
a processor circuit configured to:
determine, based on the point cloud data, a plurality of point clusters,
select, from among the plurality of point clusters, at least one point cluster satisfying both a location condition and a dimension condition corresponding to a special-purpose vehicle,
based on a plurality of reference heights measured from a ground surface of the surrounding environment of the vehicle, classify the selected at least one point cluster into at least one height-specific point cluster,
extract outer points outlining the at least one height-specific point cluster and determine lengths associated with the outer points,
identify, based on spatial coordinates of the outer points, at least one parameter corresponding to the plurality of reference heights,
compare the at least one parameter to at least one reference parameter and compare the lengths to reference lengths,
based on the comparisons, determine that the selected at least one point cluster corresponds to the special-purpose vehicle,
update, based on the determination, at least one of a bounding box associated with the object or a heading angle associated with the object,
output a signal indicating the updated bounding box or heading angle, and
control, via the driving control circuit and based on the signal, driving of the vehicle.

17. The vehicle of claim 16, wherein the processor circuit is configured to:
process the point cloud data to remove ground points and cluster remaining points into the plurality of point clusters,
divide the at least one height-specific point cluster into a plurality of angular sectors relative to a position of the sensor, and
select, as the outer points, nearest points to the position of the sensor within respective angular sectors of the plurality of angular sectors,
wherein the at least one parameter comprises a set of polynomial coefficients corresponding to the plurality of reference heights, and
wherein the at least one reference parameter comprises reference polynomial coefficients.

18. The vehicle of claim 16, wherein the processor circuit is configured to identify a subclass of the special-purpose vehicle based on the comparisons, wherein the at least one reference parameter comprises a first reference parameter associated with a first type of special-purpose vehicle and a second reference parameter associated with a second type of special-purpose vehicle, and wherein the reference lengths comprises a first reference length associated with the first type of special-purpose vehicle and a second reference length associated with the second type of special-purpose vehicle.

19. The vehicle of claim 16, wherein the processor circuit is configured to:
determine slope values of the point cloud data at different heights, and
classify points of the point cloud data, as ground or non-ground, based on the slope values and based on the surrounding environment comprising a tunnel.

20. The vehicle of claim 16, wherein the processor circuit is configured to determine that the selected at least one point cluster corresponds to the special-purpose vehicle based on a dimension satisfying a threshold value, wherein the dimension is determined based on the outer points, and wherein the threshold value is determined based on reference data comprising sets of polynomial-fit values corresponding to outer contours of the object.
